(19) United States
(12) Patent Application Publication
(10) Pub. No.: US 2008/0279787 A1
(43) Pub. Date: Nov. 13, 2008

(54) Hard Surface Disinfecting Compositions Comprising Poorly Aqueous Soluble Quaternary Ammonium Compounds

(75) Inventors: Tak Wai Cheung, Yuma, AZ (US); Alan James Thomas, Montvale, NJ (US); Jeanne Marie Weller, Montvale, NJ (US)

Correspondence Address: NORRIS, MCLAUGHLIN & MARCUS, 875 THIRD AVE, 18TH FLOOR, NEW YORK, NY, 10022, US

(73) Assignee: RECKITT BENCKISER, INC., Parsippany, NJ (US)

(21) Appl. No.: 11/908,318

(22) PCT Filed: Jan. 20, 2006
(86) PCT No.: PCT/GB2006/000214

§ 371 Date: Apr. 29, 2008

(30) Foreign Application Priority Data
Mar. 15, 2005 (GB) 0505236.0

(51) Int. Cl. A01N 33/12; A01N 25/06; A01P 1/00

(52) U.S. Cl. 424/45; 514/642

(57) ABSTRACT

Disinfecting compositions based on one or more poorly aqueous soluble quaternary ammonium compounds which exhibit reduced corrosion tendencies, one or more nonionic surfactants, optionally one or more further constituents particularly those which enhance the appearance of the compositions, wherein the compositions are largely aqueous in nature and includes little or no organic solvents. The compositions may be formulated as aerosol compositions, or may be provided as non-pressurized liquid compositions. The disinfecting compositions provide excellent efficacy against Staphylococcus aureus, Salmonella choleraesuis and Escherichia coli.

This application is filed under 35 USC 371 of PCT/GB2006/000214.

The present invention relates to improved compositions comprising quaternary ammonium compounds which provide a disinfecting or sanitizing effect to treated hard surfaces.

Quaternary ammonium compounds are known to be effective in the treatment of hard surfaces, particularly to provide a sanitizing benefit to such treated hard surfaces. The compounds are generally cationic in nature and are widely commercially available from a number of sources, and they are frequently combined in formulations with one or more further synthetic surfactants, as well as one or more organic solvents in order to provide a beneficial cleaning benefit to a treated hard surface. Such formulations may be formulated as non-pressurized liquids including concentrated compositions intended to be further diluted with water in order form a cleaning and/or disinfecting composition, as well as in pressurized containers such as aerosol vessels or canisters from which a formulation is dispensed by a consumer.

A shortcoming of such known-art compositions is that, while the use of quaternary ammonium compounds in such formulations do provide a useful germicidal benefit, unfortunately these materials have often been observed to be particularly corrosive in many instances when packaged in conventional canisters especially aerosol canisters. It has been observed that very frequently the counterion of the quaternary ammonium compounds are often the cause of such corrosion particularly when the counterions are based on halogens, especially when based on chlorine. Such corrosion may lead to localized corrosion, pitting as well as premature failure, via leakage and the formation of pinholes through the metal of aerosol canisters. This problem is particularly acute in the regions of weldlines and seams wherein the metal has been subjected to mechanical or thermal stresses during the manufacturing process of the canister.

While certain aerosol compositions and commercial products are also known which include one or more quaternary ammonium compounds which exhibit reduced corrosion tendencies, these aerosol formulations require the presence of a high proportion, generally at least 50% wt. of one or more organic solvents which are required to solubilize or suspend these quaternary ammonium compounds within the formulation. While effective, aerosol compositions and commercial products inherently release a significant amount of volatile constituents to the atmosphere when the formulation is dispensed from an aerosol container which is undesirable in many areas.

The present invention addresses and overcomes these and other technical shortcomings in the art attendant upon many prior art compositions which provide a disinfecting or sanitizing benefit to hard surfaces, optionally in conjunction with a cleaning benefit as well.

In a first aspect of the present invention there is provided a disinfecting or sanitizing aerosol composition which includes one or more poorly aqueous soluble quaternary ammonium compounds which exhibit reduced corrosion tendencies, one or more nonionic surfactants, optionally one or more further constituents particularly those which enhance the appearance of the compositions, and a propellant, wherein the aerosol composition is largely aqueous in nature and includes a minor amount of one or more volatile organic solvents, generally less than 20% wt., preferably even lesser amounts.

According to a second aspect of the invention there is provided an aerosol composition according to the first aspect of the invention which comprises not more than about 10% wt. volatile organic solvents.

In a third aspect of the invention there is provided an aerosol composition according to the first and second aspects of the invention which is effective in providing a disinfecting or sanitizing effect to surfaces, particularly hard surfaces, treated with the said aerosol composition.

According to a fourth aspect of the invention there is provided an aerosol composition according to the first, second or third aspects of the invention wherein the aerosol composition is provided as a pressurized composition in an aerosol container.

According to a fifth aspect of the invention there is provided a disinfecting or sanitizing non-aerosol composition which includes one or more poorly aqueous soluble quaternary ammonium compounds which exhibit reduced corrosion tendencies, one or more nonionic surfactants, optionally one or more further constituents particularly those which enhance the appearance of the compositions, wherein the non-aerosol composition is largely aqueous in nature and includes a minor amount of one or more volatile organic solvents, generally less than 20% wt., preferably even lesser amounts.

According to a sixth aspect of the invention there is provided a non-aerosol composition according to the fifth aspect of the invention which comprises not more than about 10% wt. volatile organic solvents.

According to a seventh aspect of the invention there is provided a disinfecting or sanitizing composition according to the sixth or seventh aspects of the invention provided in a non-pressurized container.

In an eighth aspect of the invention there is provided a disinfecting or sanitizing composition according to the fifth or sixth aspect of the invention which is effective in providing a disinfecting or sanitizing effect to surfaces, particularly hard surfaces, treated with the said non-aerosol composition.

In a ninth aspect of the invention there is provided a method for the treatment of surfaces, particularly hard surfaces, wherein the presence of undesired microorganisms are suspected such as gram positive or gram negative bacteria, which method includes the step of applying a disinfecting or sanitizing effective amount of a composition according to any of the first through eighth aspects of the invention to the surface.

According to a tenth aspect of the invention there are provided methods for the manufacture of compositions according to any of the first through eighth aspects of the invention.

The compositions according to the invention comprise at least one poorly aqueous soluble quaternary ammonium compound. These poorly aqueous soluble quaternary ammonium compounds include at least one quaternary ammonium compound having a non-halogen containing counterion; preferred are quaternary ammonium compounds and salts thereof, which may be characterized by the general structural formula:

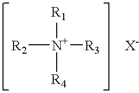

where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons usually containing no more than 12 carbon atoms. The substituents R₁, R₂, R₃ and R₄ may be straight-chained or may be branched, but are preferably straight-chained, and may include one or double bonds as well as one or more amide, ether or ester linkages. The counterion X may be a non-halogenated salt-forming anion which renders the quaternary ammonium complex to be poorly soluble in water. Preferably the anion is based on one or more saccharinate counterions.

Preferably the at least one quaternary ammonium compound having a non-halogen containing counterion may be represented as:

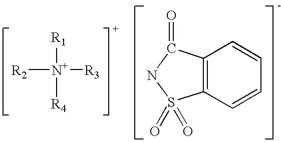

with the values of R₁, R₂, R₃ and R₄ being as recited above. Most preferably however, both R₁ and R₄ are independently selected from hydrogen or lower alkyl constituents, particularly methyl, ethyl or propyl; R₂ is a C₁₀-C₂₀ alkyl constituent, preferably C₁₂-C₁₆ alkyl and R₃ is an aryl constituent, a C₁-C₂₄ alkyl constituent but preferably is an alkylaryl constituent.

Most preferred as the at least one quaternary ammonium compound is Onyxide 3300® (ex. Lonza Inc. (Fairlawn, N.J.)) described by its manufacturer as a compound which may be characterized by the general structural formula:

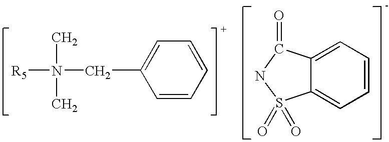

wherein R₅ is a C₁₀₋₂₀, preferably C₁₂₋₁₆ alkyl group which may optionally include one or double bonds as well as one or more amide, ether or ester linkages.

With respect to the term “poorly aqueous soluble” with respect to the at least one quaternary ammonium compound is to be understood that the aqueous solubility of the quaternary ammonium compound in deionized water at 20° C. is not more than 0.1% wt., preferably is not more than 0.05% wt., and yet more preferably is not more than 0.03% wt., still more preferably is not more than 0.02% wt. and especially preferably is not more than 0.01% wt, based on the total weight of the mixture of deionized water and the quaternary ammonium compound. Most desirably sufficient poorly aqueous soluble quaternary ammonium compound is present in the inventive compositions so that a useful sanitizing or disinfecting effect is achieved, but precipitation of the poorly aqueous soluble quaternary ammonium compound does not occur, nor does clouding of the inventive compositions occur when stored for at least 4 weeks at room temperature conditions, more desirably when stored for at least 4 weeks at elevated temperatures as described hereinafter.

The at least one quaternary ammonium compound may be present in any effective amount, but generally need not be present in amounts in excess of about 10% wt. based on the total weight of the aerosol composition. The preferred at least one quaternary ammonium compound (s) may be present in the aerosol compositions in amounts of from about 0.001% by weight to up to about 10% by weight, very preferably about 0.01-8% by weight, more preferably in amount of between 0.5-6% by weight, and most preferably from 2-4% by weight.

It is particularly advantageous that the preferred at least one quaternary ammonium compound(s) are present in amounts of at least 200 parts per million (ppm), preferably in amounts of 200-700 ppm, more preferably in amounts of from 250-500 ppm, and very especially in amount of from 300-500 ppm.

The inventors have surprisingly found that the poorly aqueous soluble quaternary ammonium complex particularly which includes a saccharinate counterion may nonetheless be formulated into aqueous compositions which are largely aqueous in composition. Such is a surprising and unexpected result particularly when understood that the poorly aqueous soluble quaternary ammonium complexes typically exhibit solubility only in organic solvents such as alcohols, or in aqueous-alcoholic mixtures wherein alcohol is present in an amount at least equal to the amount of water present. Such poorly aqueous soluble quaternary ammonium complex particularly which includes saccharinate counterions typically are provided as a dry solid, or in a liquid carrier medium which comprises at least 50% of one or more organic solvents which are provided so avoid the formation of precipitates. For example the commercially available form of the poorly aqueous soluble quaternary ammonium complex particularly which includes a saccharinate counterion currently sold as Onyxide 3300® is provided as a blend of 33% wt. of the quaternary ammonium complex with the balance being a lower monohydric alcohol, e.g., ethanol. The monohydric alcohol may be extracted from the Onyxide 3300® commercial preparation, or alternately the poorly aqueous soluble quaternary ammonium complex particularly having the saccharinate counterion as provided in the Onyxide 3300® commercial preparation may be obtained in a solid form as well.

Notwithstanding these technical limitations, the inventors have found that stable formulations which include only minor amounts of one or more volatile organic solvents can be produced.

The compositions according to the present invention necessarily further include at least one nonionic surfactant. Generally any nonionic surfactant material may be used in the inventive compositions. Practically any hydrophobic compound having a carboxy, hydroxy, amido, or amino group with a free hydrogen attached to the nitrogen can be condensed with an alkylene oxide, especially ethylene oxide or with the polyhydration product thereof, a polyalkylene glycol, especially polyethylene glycol, to form a water soluble or water dispersible nonionic surfactant compound. By way of non-limiting example, particularly examples of suitable nonionic surfactants which may be used in the present invention include the following:

One class of useful nonionic surfactants include polyalkylene oxide condensates of alkyl phenols. These compounds include the condensation products of alkyl phenols having an alkyl group containing from about 6 to 12 carbon atoms in either a straight chain or branched chain configuration with an alkylene oxide, especially an ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

A further class of useful nonionic surfactants include the condensation products of aliphatic alcohols with from about 1 to about 60 moles of an alkylene oxide, especially an ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 18 carbon atoms). Other examples are those C₆-C₁₈ straight-chain alcohols which are ethoxylated with from about 3 to about 6 moles of ethylene oxide. Their derivation is well known in the art. Examples include Alfonic® 810-4.5, which is described in product literature from Sasol as a C8-10 having an average molecular weight of 356, an ethylene oxide content of about 4.85 moles (about 60 wt. %), and an HLB of about 12; Alfonic® 810-2, which is described in product literature as a C8-10 having an average molecular weight of 242, an ethylene oxide content of about 2.1 moles (about 40 wt. %), and an HLB of about 12; and Alfonic® 610-3.5, which is described in product literature as having an average molecular weight of 276, an ethylene oxide content of about 3.1 moles (about 50 wt. %), and an HLB of 10. Other examples of alcohol ethoxylates are CIO oxo-alcohol ethoxylates available from BASF under the Lutensol® ON tradename. They are available in grades containing from about 3 to about 11 moles of ethylene oxide (available under the names Lutensol® ON 30; Lutensol® ON 50; Lutensol® ON 60; Lutensol® ON 65; Lutensol® ON 66; Lutensol® ON 70; Lutensol® ON 80; and Lutensol®ON 110). Other examples of ethoxylated alcohols include the Neodol® series non-ionic surfactants available from Shell Chemical Company which are described as C₉-C₁₁ ethoxylated alcohols. The Neodol® 91 series non-ionic surfactants of interest include Neodol® 91-2.5, Neodol® 91-6, and Neodol® 91-8. Neodol® 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Further members of the Neodol® series including those of the Neodol® 25 series as well as the Neodol® 45 series are of particular interest, and include, inter alia, Neodol® 25-9 described as C₁₂-C₁₅ ethoxylated alcohols with about 9 ethoxy groups per molecule and Neodol® 45-7 described as C₁₄-C₁₅ ethoxylated alcohols with about 7 ethoxy groups per molecule. Other members of the Neodol® series of ethoxylated alcohols are also considered to be particularly suitable for use in the compositions of the present invention and are in certain instances, examples of preferred nonionic surfactants. Further examples of ethoxylated alcohols include the Rhodasurf® DA series non-ionic surfactants available from Rhodia which are described to be branched isodecyl alcohol ethoxylates. Rhodasurf® DA-530 has been described as having 4 moles of ethoxylation and an HLB of 10.5; Rhodasurf® DA-630 has been described as having 6 moles of ethoxylation with an HLB of 12.5; and Rhodasurf® DA-639 is a 90% solution of DA-630. Further examples of ethoxylated alcohols include those from Tomah Products (Milton, Wis.) under the Tomadol® tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C₉/C₁₀/C₁₁ and n is 2.5, 6, or 8; 1-3; 1-5; 1-7; 1-73B; 1-9; where R is linear C₁₁ and n is 3, 5, 7 or 9; 23-1; 23-3; 23-5; 23-6,5—where R is linear C₁₂/C₁₃ and n is 1, 3, 5, or 6.5; 25-3; 25-7; 25-9; 25-12—where R is linear C₁₂/C₁₃/C₁₄/C₁₅ and n is 3, 7, 9, or 12; and 45-7; 45-13—where R is linear C₁₄/C₁₅ and n is 7 or 13.

A further class of useful nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol® UD (ex. Clariant, Charlotte, N.C.) described under the tradenames Genapol® UD 030, C₁₁-oxo-alcohol polyglycol ether with 3 EO; Genapol® UD, 050 C₁₁-oxo-alcohol polyglycol ether with 5 EO; Genapol® UD 070, C₁₁-oxo-alcohol polyglycol ether with 7 EO; Genapol® UD 080, C₁₁-oxo-alcohol polyglycol ether with 8 EO; Genapol® UD 088, C₁₁-oxo-alcohol polyglycol ether with 8 EO; and Genapol® UD 110, C₁₁-oxo-alcohol polyglycol ether with 11 EO.

A further class of useful nonionic surfactants include those surfactants having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename. available from Clariant, which surfactants include the “26-L” series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1,26-L-1.6, 26-L-2,26-L-3,26-L-5,26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3,24-L-45, 24-L-50, 24-L-60, 24-L-60N, 24-L-75, 24-L-92, and 24-L-98N.

A further class of useful nonionic surfactants include alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}-H (A)

where
EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC (ex. BASF) or Emulgen (ex. Kao.)

A further group of such useful nonionic surfactants containing the characteristic alkylene oxide blocks are those can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block. Specific nonionic surfactants which in general are encompassed by Formula B include butoxy derivatives of propylene oxide/ethylene oxide block polymers having molecular weights within the range of about 2000-5000.

Still further examples of useful nonionic surfactants include those which can be represented by formula (C) as follows:

RO—(BO)ₙ(EO)ₓ-H (C)

wherein
EO represents ethylene oxide,
BO represents butylene oxide,
R is an alkyl group containing I to 20 carbon atoms,
n is about 5-15 and x is about 5-15.

Yet further useful nonionic surfactants include those which may be represented by the following formula (D):

HO-(EO)ₓ(BO)ₙ(EO)_{y}-H (D)

wherein
EO represents ethylene oxide,
BO represents butylene oxide,
n is about 5-15, preferably about 15,
x is about 5-15, preferably about 15, and
y is about 5-15, preferably about 15.

Still further exemplary useful nonionic block copolymer surfactants include ethoxylated derivatives of propoxylated ethylene diamine, which may be represented by the following formula:

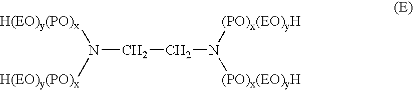

where
(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

Further useful as nonionic surfactants are one or more amine oxide compounds. Exemplary useful amine oxides include those which may be defined as one or more of the following of the four general classes:

(1) Alkyl di (lower alkyl) amine oxides in which the alkyl group has about 6-24, and preferably 8-18, carbon atoms and can be straight or branched chain, saturated or unsaturated. The lower alkyl groups include from 1 to 7 carbon atoms, but preferably each include 1-3 carbon atoms. Examples include octyldimethylamine oxide, lauryldimethylamine oxide, myristyldimethylamine oxide, and those in which the alkyl group is a mixture of different amine oxides, such as dimethylcocoamineoxide, dimethyl(hydrogenated tallow)amine oxide, and myristyl/palmityldimethylamine oxide;

(2) Alkyl di (hydroxy lower alkyl) amine oxides in which the alkyl group has about 6-22, and preferably 8-18, carbon atoms and can be straight or branched chain, saturated or unsaturated. Examples include bis-(2-hydroxyethyl)cocoamine oxide, bis-(2-hydroxyethyl) tallowamine oxide; and bis-(2-hydroxyethyl)stearylamine oxide;

(3) Alkylamidopropyl di(lower alkyl) amine oxides in which the alkyl group has about 10-20, and preferably 12-16, carbon atoms and can be straight or branched chain, saturated or unsaturated. Examples are cocoamidopropyldimethylamine oxide and tallowamidopropyldimethylamine oxide; and

(4) Alkylmorpholine oxides in which the alkyl group has about 10-20, and preferably 12-16, carbon atoms and can be straight or branched chain, saturated or unsaturated.

The preferred amine oxides are those which may be represented by the structure:

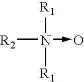

wherein
each R₁ independently is a straight chained C₁-C₄ alkyl group, preferably both R₁ are methyl groups; and
R₂ is a straight chained C₆-C₂₂ alkyl group, preferably a C₆-C₁₆ alkyl group, and most preferably is a C₈₋₁₀ alkyl group, especially a C₈ alkyl group;

Each of the alkyl groups may be linear or branched, but preferably are linear. Most preferably the amine oxide constituent is lauryldimethylamine oxide. Technical grade mixtures of two or more amine oxides may be used, wherein amine oxides of varying chain lengths of the R₂ group. Preferably, the amine oxides used in the present invention include R₂ groups which comprise at least 50% wt., preferably at least 75% wt., of C₈ alkyl group.

Exemplary and preferred amine oxide compounds include N-alkyldimethylamine oxides, particularly octyldimethylamine oxides, decyldimethylamine oxides, lauryldimethylamine oxides as well as myristyldimethylamine oxide. These amine oxide compounds are available as surfactants from McIntyre Group Ltd. under the name Mackamine® C-8 which is described as a 40% by weight active solution of octyldimethylamine oxide, as well as from Stepan Co., under the trade names Ammonyx® DO which is described to be as a 30% wt. active solution of decyldimethylamine oxide and Ammonyx® LO which is described to be as a 30% wt. active solution of lauryldimethylamine oxide.

Further exemplary useful nonionic surfactants which may be used include certain alkanolamides including monoethanolamides dialkanolamines, trialkanolamines, and alkylalkanolamines such as alkyl-dialkanolamines, and dialkyl-monoalkanolamines and particularly fatty monoalkanolamides and fatty dialkanolamides. The alkanol and alkyl groups may be generally short to medium chain length, that is, from 1 to 7 carbons in length. For di- and trialkanolamines and dialkyl-monoalkanolamines, these groups can be combined on the same amine to produce for example, methylethylhydroxypropylhydroxylamine.

Of course the nonionic surfactant constituent may comprise two or more nonionic surfactants in according to certain preferred embodiments blends of nonionic surfactants are necessarily present, with an amine oxide being necessarily present in conjunction with at least one further nonionic surfactant, as such provide excellent cleaning and excellent foaming particularly when dispensed from a pressurized aerosol container. Particularly advantageous blends of nonionic surfactants are disclosed in the Examples.

The nonionic surfactant is present in the compositions of the present invention in an amount of from about 0.1 to about 12% by weight, more preferably is present in an amount of from about 1-9% wt., and most preferably is present in an amount of from about 2-6% wt. Particularly preferred amounts are also described with reference to the examples described hereinafter.

In addition to the at least one nonionic surfactant noted above, the inventive compositions may further include one or more additional surfactants which may improve the detersive effect of the compositions while at the same time, not undesirably detracting from the solubility of the quaternary ammonium compound or by forming an insoluble complex with the quaternary ammonium compound and causing its precipitation. Such further optional surfactants include one or more selected from further nonionic, cationic, amphoteric and zwitterionic surfactants. The inclusion of anionic surfactants is desirably to be avoided as such are expected to form insoluble complexes with the cationic quaternary ammonium compound present, although in some instances Also useful as the anionic surfactants based on carboxylates such as alkyl carboxylates, or polyalkoxycarboxylates may be used. Exemplary further surfactants include zwitterionic surfactants which can be broadly described as derivatives of secondary and tertiary amines, derivatives of heterocyclic secondary and tertiary amines, or derivatives of quaternary ammonium, quaternary phosphonium or tertiary sulfonium compounds, e.g., betaine and sultaine surfactants. Exemplary betaine surfactants include alkylbetaines, particularly those which may be represented by the following structural formula:

RN(CH₃)₂CH₂COO⁻

wherein R is a straight or branched hydrocarbon chain which may include an aryl moiety, but is preferably a straight hydrocarbon chain containing from about 6 to 30 carbon atoms. Further exemplary useful amphoteric surfactants include amidoalkylbetaines, such as amidopropylbetaines which may be represented by the following structural formula:

RCONHCH₂CH₂CH₂N⁺(CH₃)₂CH₂COO⁻

wherein R is a straight or branched hydrocarbon chain which may include an aryl moiety, but is preferably a straight hydrocarbon chain containing from about 6 to 30 carbon atoms. Further exemplary surfactants include amphoteric surfactants such as alkyl amphocarboxylic acids, such as an alkyl amphodicarboxylic acid commercially available as Miranol® C2M Conc. (ex. Miranol, Inc., Dayton, N.J.)

When present such further additional surfactants may be present in the compositions of the present invention in a total amount of to about 15% by weight, and when present are preferably is present in a total amount of from about 2-6% wt., and most preferably is present in a total amount of from about 3 to about 5% wt. Particularly preferred amounts of such additional surfactants, when present, are also indicated in one or more of the examples described hereinafter.

As the inventive compositions are largely aqueous in nature, water is added in order to provide 100% by weight of the compositions of the invention. The water may be tap water, but is preferably distilled and/or deionized water. If the water is tap water, it is preferably appropriately filtered in order to remove any undesirable impurities such as organics or inorganics, especially minerals salts which are present in hard water which may thus interfere with the operation of the other constituents of the invention, as well as any other optional components of the compositions according to the invention.

A minor amount, up to about 20% wt. of the inventive compositions may be comprised of one or more organic solvents. Examples of organic solvents include those which are at least partially water-miscible such as monohydric (straight chained or branched) primary, secondary or tertiary lower aliphatic alcohols, especially C₁-C₆ aliphatic primary and secondary alcohols, water-miscible ethers including those having the general structure R′—O—R″—OH, wherein R′ is an alkoxy of 1 to 20 carbon atoms, or aryloxy of at least 6 carbon atoms, and R″ is an ether condensate of propylene glycol and/or ethylene glycol having from one to ten glycol monomer units, e.g. diethylene glycol diethylether, diethylene glycol dimethylether, propylene glycol dimethylether; water-miscible glycol ether, e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether; lower esters of monoalkylethers of ethylene glycol or propylene glycol, e.g. propylene glycol monomethyl ether acetate; pyrrolidone and pyrrolidone derivatives e.g., n-methyl-pyrrolidone; aromatic hydrocarbons comprising compounds having C₅, C₆ and C₇ rings, as well as mixtures of one or more such organic solvents. Further examples of organic solvents include hydrocarbon compounds especially C₁-C₆ organic hydrocarbons e.g., propane, n-butane, which are known to be useful as propellants or components of propellant compositions, in aerosol applications.

Notwithstanding the sparing aqueous solubility, or insolubility of the poorly aqueous soluble quaternary ammonium complex particularly which includes a saccharinate counterion, as previously noted the inventors have found that stable formulations which include only minor amounts of one or more volatile organic solvents can be produced, generally where the compositions include such solvents in total amounts not in excess of about 20% wt., more preferably not in excess of about 16% wt., yet more preferably not in excess of about 14% wt., and most preferably not in excess of about 12% wt., and especially preferably not in excess of about 10% wt., based on the total weight of the composition, aerosolized or non-aerosolized, of which such solvents or solvents form a part. In especially preferred embodiments, the aerosolized embodiments include as volatile organic compounds only the propellant when such propellants include or are based on volatile organic compounds and any organic solvent which is supplied with the poorly aqueous soluble quaternary ammonium complex from its commercial supplier; preferably the total amounts of one or more volatile organic solvents are about 10% wt. or less, but preferably not more than 5% wt. when the propellant are based on non-volatile organic compounds such as fluorocarbons, or non non-organic materials such as pressurized gases, e.g., nitrogen, carbon dioxide, oxygen and the like. In especially preferred embodiments of non-aerosolized inventive compositions, such preferably comprise not more than 5% wt. of volatile organic compounds, preferably not more than 4% wt., still more preferably not more than 3% wt. and most desirably include only whatever organic solvent which may be supplied with the poorly aqueous soluble quaternary ammonium complex from its commercial supplier and does not include further added volatile organic solvents which might otherwise be added to the inventive composition.

The compositions of the present invention can also optionally comprise one or more further constituents which are directed to improving the aesthetic or functional features of the inventive compositions. Such conventional additives known to the art include but not expressly enumerated here may also be included in the compositions according to the invention. By way of non-limiting example without limitation these may include: chelating agents, coloring agents, light stabilizers, fragrances, thickening agents, hydrotropes, pH adjusting agents, pH buffers as well as one or more detersive surfactants as noted previously. Many of these materials are known to the art, per se, and are described in McCutcheon's Detergents and Emulsifiers, North American Edition, 1998; Kirk-Othmer, Encyclopedia of Chemical Technology, 4th Ed., Vol. 23, pp. 478-541 (1997. Such optional, i.e., non-essential constituents should be selected so to have little or no detrimental effect upon the desirable characteristics of the present invention. When present, the one or more optional constituents present in the inventive compositions do not exceed about 10% wt., preferably do not exceed 8% wt., and most preferably do not exceed 5% wt.

Advantageously included constituents are one or more coloring agents which find use in modifying the appearance of the compositions and enhance their appearance from the perspective of a consumer or other end user. Known coloring agents, such as dyestuffs may be incorporated in the compositions in effective amounts.

The compositions of the invention optionally but desirably include a fragrance constituent. Fragrance raw materials may be divided into three main groups: (1) the essential oils and products isolated from these oils; (2) products of animal origin; and (3) synthetic chemicals.

The essential oils consist of complex mixtures of volatile liquid and solid chemicals found in various parts of plants. Mention may be made of oils found in flowers, e.g., jasmine, rose, mimosa, and orange blossom; flowers and leaves, e.g., lavender and rosemary; leaves and stems, e.g., geranium, patchouli, and petitgrain; barks, e.g., cinnamon; woods, e.g., sandalwood and rosewood; roots, e.g., angelica; rhizomes, e.g., ginger; fruits, e.g., orange, lemon, and bergamot; seeds, e.g., aniseed and nutmeg; and resinous exudations, e.g., myrrh. These essential oils consist of a complex mixture of chemicals, the major portion thereof being terpenes, including hydrocarbons of the formula (C₅H₈)ₙ and their oxygenated derivatives. Hydrocarbons such as these give rise to a large number of oxygenated derivatives, e.g., alcohols and their esters, aldehydes and ketones. Some of the more important of these are geraniol, citronellol and terpineol, citral and citronellal, and camphor. Other constituents include aliphatic aldehydes and also aromatic compounds including phenols such as eugenol. In some instances, specific compounds may be isolated from the essential oils, usually by distillation in a commercially pure state, for example, geraniol and citronellal from citronella oil; citral from lemon-grass oil; eugenol from clove oil; linalool from rosewood oil; and safrole from sassafras oil. The natural isolates may also be chemically modified as in the case of citronellal to hydroxy citronellal, citral to ionone, eugenol to vanillin, linalool to linalyl acetate, and safrol to heliotropin.

Animal products used in perfumes include musk, ambergris, civet and castoreum, and are generally provided as alcoholic tinctures.

The synthetic chemicals include not only the synthetically made, also naturally occurring isolates mentioned above, but also include their derivatives and compounds unknown in nature, e.g., isoamylsalicylate, amylcinnamic aldehyde, cyclamen aldehyde, heliotropin, ionone, phenylethyl alcohol, terpineol, undecalactone, and gamma nonyl lactone.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

When the compositions of the invention are provided within a pressurized container, the addition of corrosion inhibitors are contemplated as being of use. Exemplary useful corrosion inhibitors include alkanolamine compounds such as mono- and triethanolamine, ammonium hydroxide, sodium molybdate and sodium benzoate, borates, carbonates and polycarbonates including bicarbonates, silicates, as well as other corrosion inhibitors well known to those of ordinary skill in the art. The corrosion inhibitor, when needed, is generally present in an amount of from about 0.01 to about 0.50 weight percent of the composition, preferably from about 0.05 to about 0.10 weight percent. Of course it is to be understood that if compositions of the present invention are prepared as non-aerosol compositions such corrosions inhibitors will not be necessary.

According to certain preferred aspects, the compositions according to the invention are desirably provided as a ready to use product which may be directly applied to a hard surface. The compositions may be provided in a non-pressurized container, or may be provided in a pressurized container, e.g., in an aerosol container or aerosol package.

When produced in an aerosol form, the aerosol compositions of this invention may be packaged in any suitable pressurizable container. They may be pressurized and made available in this form by means of the addition of a suitable propellant to the composition. Any propellant which can self-pressurize the composition and serve as the means for dispensing it from its container is suitable, including liquified gaseous propellants or inert compressed gases. The preferred propellants include liquified, normally gaseous propellants such as the known hydrocarbon propellants. The preferred normally gaseous hydrocarbon propellants include the aliphatic saturated hydrocarbons such as propane, butane, isobutane, and isopentane. Inert compressed gases such as CO₂, N₂ and O₂ may also be used with or without further propellant materials. Also useful but less preferred in some regions are halogenated hydrocarbons include chlorodifluoromethane, difluoroethane dichlorodifluoromethane and the like. Mixtures of two or more propellants can be used. The propellant is desirably utilized in an amount sufficient to expel the entire contents of the containers. In general, the propellant will be from about 5% to about 25%, preferably about 5% to about 15% by weight of the total aerosol composition. It is to be recognized that certain classes of these propellants are volatile organic compounds and when included in aerosol forms of the inventive compositions they are most desirably present in amounts of not in excess of the maximum but advantageously not in excess of one or more of the preferred ranges recited above particularly if any further non-propellant, volatile organic solvents are present in aerosol forms of the inventive compositions.

The pH of the compositions of the invention are generally in the range of from about 6 to about 9, preferably in the range of about 7 to 8, most preferably are in a pH range of about 7 to about 7.6. The addition of pH adjusting agents, or pH buffers in minor but effective amounts are contemplated if necessary to achieve these levels.

Preferred compositions of the invention are shelf stable and exhibit good freeze/thaw stability, and also good stability without suffering phase separation following storage of the compositions for 4 weeks, preferably 8 weeks, and most preferably 12 weeks both at room temperature and particularly at the elevated temperature of 120° F. (49° C.).

According to further preferred embodiments the compositions of the invention are provided in a non-pressurized container or vessel, without a propellant constituent. Such may be for example a rigid or deformable container such as a bottle from which the composition may be dispensed by pouring, or may be a container supplied with a pump or trigger-spray apparatus which, when operated, dispenses the composition from the container as a spray.

As noted, the compositions of the invention may be provided in either in a pressurized dispenser vessel such as any of a number of known-art aerosol canisters, or may be supplied in a liquid, non-pressurized vessel such as bottle or other container. When supplied in the latter form, it is to be understood that the inventive compositions may be used in an as supplied, concentrate form may be used directly without dilution, i.e., in concentrate:water concentrations of 1:0, or may be dispersed or mixed into an additional volume of water to form diluted compositions. Generally useful dilutions are those where the as supplied concentrate is diluted with water in respective proportions of 1:0.1-1:1000, preferably 1:1-1:500 but most preferably in respective proportions of 1:10-1:100. The actual useful dilution selected is in part determinable by the condition of the surface to be treated with such a diluted composition; generally better cleaning results and faster antimicrobial efficacy is to be expected at lower relative dilutions of the concentrate in water. Such dilution ratios of concentrate:water as described above may be volume/volume basis, or a weight/weight basis.

The non-aerosol forms of the compositions may also be applied to a hard surface by using a wet wipe. The wipe can be of a woven or non-woven nature. Fabric substrates can include nonwoven or woven pouches, sponges, in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former.

The nonwoven fabrics may be a combination of wood pulp fibers and textile length synthetic fibers formed by well known dry-form or wet-lay processes. Synthetic fibers such as rayon, nylon, orlon and polyester as well as blends thereof can be employed. The wood pulp fibers should comprise about 30 to about 60 percent by weight of the nonwoven fabric, preferably about 55 to about 60 percent by weight, the remainder being synthetic fibers. The wood pulp fibers provide for absorbency, abrasion and soil retention whereas the synthetic fibers provide for substrate strength and resiliency.

The substrate of the wipe may also be a film forming material such as a water soluble polymer. Such self-supporting film substrates may be sandwiched between layers of fabric substrates and heat sealed to form a useful substrate. The free standing films can be extruded utilizing standard equipment to devolatilize the blend. Casting technology can be used to form and dry films or a liquid blend can be saturated into a carrier and then dried in a variety of known methods.

The compositions of the present invention are absorbed onto the wipe to form a saturated wipe. The wipe can then be sealed individually in a pouch which can then be opened when needed or a plurality of wipes can be placed in a container for use on an as needed basis. The container, when closed, sufficiently sealed to prevent evaporation of any components from the compositions.

The compositions according to the invention are particularly useful in the treatment of surfaces, especially hard surfaces. By way of non-limiting example, hard surfaces include surfaces composed of refractory materials such as: glazed and unglazed tile, brick, porcelain, ceramics including vitroceramics, as well as stone including marble, granite, and other stones surfaces; glass; metals; plastics e.g. polyester, vinyl; fiberglass, and other hard surfaces known to the art. Hard surfaces which are to be particularly denoted are lavatory fixtures such as shower stalls, bathtubs and bathing appliances (racks, curtains, shower doors, shower bars) toilets, bidets, wall and flooring surfaces especially those which include refractory materials or metal surfaces and the like. Further hard surfaces which are to be denoted are those associated with kitchen environments and other environments associated with food preparation, including cabinets and countertop surfaces as well as walls and floor surfaces especially those which include refractory materials, plastics, and stone. Such hard surfaces described above are to be understood as being recited by way of illustration and not be way of limitation.

Preferred embodiments of the inventive compositions are particularly effective in methods for the treatment of surfaces, particularly hard surfaces, wherein the presence of undesired microorganisms such as gram positive or gram negative bacteria, as well as other microorganisms are suspected. The contemplated method includes the step of applying a disinfecting or sanitizing effective amount of either the aerosol composition, or of the non-pressurized composition according to the invention to the surface upon which the presence of undesired microorganisms are known or suspected.

The following examples below illustrate exemplary formulations as well as certain particularly preferred embodiments of the invention. It is to be understood that these examples are provided by way of illustration only and that further useful formulations falling within the scope of the present invention and the claims may be readily produced by one skilled in the art without deviating from the present inventive teaching.

### EXAMPLES

A number of formulations were produced by mixing the constituents outlined in Table 1 by adding the individual constituents into a beaker of deionized water at room temperature which was stirred with a conventional magnetic stirring rod. The order of addition is not critical, but good results are obtained where the surfactants are added to the water prior to the remaining constituents. Stirring continued until the formulation was homogenous in appearance. It is to be noted that the constituents might be added in any order, but it is preferred that a major proportion of water be the initial constituent provided to a mixing vessel or apparatus as it is the major constituent and addition of the further constituents thereto is convenient. The exact compositions of the example formulations are listed on Table 1, below.

TABLE 1

| Constituent | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| decyldimethylamine oxide | 3.33 | 2.4 | 0.8 | 0.8 | 0.8 | 0.8 | 0.8 | 0.8 | 2.4 | 5 |
| C₉₋₁₁ alcohol ethoxylate, 6 | 3 | 2 | — | — | — | — | — | — | — | — |
| moles EO | | | | | | | | | | |
| C₉₋₁₁ alcohol ethoxylate, 8 | — | — | — | 1 | — | — | — | — | — | — |
| moles EO | | | | | | | | | | |
| C₈₋₁₀ alcohol ethoxylate, 4.5 | — | — | 1 | — | 1 | 1 | 1 | 2 | — | — |
| moles EO | | | | | | | | | | |
| ethoxylated coco-fatty acid | 2 | — | — | — | — | — | — | — | — | — |
| quaternary ammonium | 1.51 | 1 | 1 | 1 | 1 | 1 | 1 | 1 | 1 | 1 |
| complex with saccharinate | | | | | | | | | | |
| counterion | | | | | | | | | | |
| coloring agent | 0.0056 | 0.0056 | 0.0056 | 0.056 | 0.0056 | 0.0056 | 0.0056 | 0.0056 | 0.0056 | 0.0056 |
| fragrance (proprietary) | 0.3 | 0.3 | 0.3 | 0.3 | 0.3 | 0.3 | 0.3 | 0.3 | 0.3 | 0.3 |
| sodium carbonate | — | — | — | — | 0.1 | — | — | — | — | — |
| sodium bicarbonate | — | — | — | — | — | — | 0.1 | — | — | — |
| sodium molybdate | — | — | — | — | — | 0.1 | — | — | — | — |
| sodium silicate | — | — | — | — | — | — | — | 0.1 | — | — |
| deioinized water | q.s. | q.s. | q.s. | q.s. | q.s. | q.s. | q.s. | q.s. | q.s. | q.s. |
| Constituent | Ex. 11 | Ex. 12 | Ex. 13 | Ex. 14 | Ex. 15 | Ex. 16 | Ex. 17 | Ex. 18 | Ex. 19 | Ex. 20 |
| decyldimethylamine oxide | 1.5 | 2.4 | 1.35 | 2 | 2 | 2 | 2 | — | 1.5 | 1.5 |
| lauryldimethyl amine oxide | — | — | 1.35 | — | — | — | — | — | — | — |
| C₉₋₁₁ alcohol ethoxylate, 6 | — | — | — | — | — | — | — | — | — | — |
| moles EO | | | | | | | | | | |
| C₉₋₁₁ alcohol ethoxylate, 8 | 3 | 1.5 | 1.5 | — | 3 | — | 2 | 2.5 | 2 | — |
| moles EO | | | | | | | | | | |
| C₈₋₁₀ alcohol ethoxylate, 4.5 | — | — | — | 1 | — | 1.5 | — | — | — | 2 |
| moles EO | | | | | | | | | | |
| PEG-8 laurate | — | — | — | — | — | — | — | — | — | 5 |
| PEG-12 dilaurate | — | — | — | 5 | — | | — | — | — | — |
| EO/PO block copolymer1 | — | — | — | — | — | 5 | — | — | — | — |
| EO/PO block copolymer2 | — | — | — | — | — | — | — | 5 | 5 | 5 |
| quaternary ammonium | 1 | 1 | 1 | 1 | 1 | 1 | 1 | 1.65 | 1 | 1 |
| complex with saccharinate | | | | | | | | | | |
| counterion | | | | | | | | | | |
| coloring agent | 0.0056 | 0.0056 | 0.0056 | 0.056 | 0.056 | 0.0056 | 0.0056 | 0.0056 | 0.0056 | 0.0056 |
| fragrance (proprietary) | 0.3 | 0.3 | 0.3 | 0.3 | 0.3 | 0.3 | 0.3 | 0.3 | 0.3 | 0.3 |
| deioinized water | q.s. | q.s. | q.s. | q.s. | q.s. | q.s. | q.s. | q.s. | q.s. | q.s. |
| Constituent | Ex. 21 | Ex. 22 | Ex. 23 | Ex. 24 | Ex. 25 | Ex. 26 | Ex. 27 | Ex. 28 | Ex. 29 | Ex. 30 |
| decyldimethylamine oxide | 1.5 | 2.4 | 2.4 | 2.4 | 3 | 3 | 3 | 3 | 3 | 3 |
| C₉₋₁₁ alcohol ethoxylate, 6 | — | — | — | 1 | 3 | — | 3 | — | 5 | 5 |
| moles EO | | | | | | | | | | |
| C₉₋₁₁ alcohol ethoxylate, 8 | 1.5 | — | 2.5 | — | — | 3 | — | 3 | — | 2 |
| moles EO | | | | | | | | | | |
| C₈₋₁₀ alcohol ethoxylate, 4.5 | — | 2 | — | — | — | — | — | — | — | — |
| moles EO | | | | | | | | | | |
| PEG-8 laurate | — | — | — | — | — | — | 2 | 2 | — | — |
| PEG-12 dilaurate | — | — | — | 2 | — | — | — | — | 2 | — |
| EO/PO block copolymer1 | — | — | — | — | — | — | — | — | — | — |
| EO/PO block copolymer2 | 4 | — | 4 | — | — | — | — | — | — | 5 |
| quaternary ammonium | 1.5 | 1 | 1.5 | 1.5 | 1.5 | 1.5 | 1.5 | 1.5 | 1.5 | 1.5 |
| complex with saccharinate | | | | | | | | | | |
| counterion | | | | | | | | | | |
| coloring agent | 0.0056 | 0.0056 | 0.0056 | 0.056 | 0.056 | 0.0056 | 0.0056 | 0.0056 | 0.0056 | 0.0056 |
| fragrance (proprietary) | 0.3 | 0.3 | 0.3 | 0.3 | 0.3 | 0.3 | 0.3 | 0.3 | 0.3 | 0.3 |
| deioinized water | q.s. | q.s. | q.s. | q.s. | q.s. | q.s. | q.s. | q.s. | q.s. | q.s. |
| Constituent | Ex. 31 | Ex. 32 | Ex. 33 | Ex. 34 | Ex. 35 | Ex. 36 | Ex. 37 | Ex. 38 | Ex. 39 | Ex. 40 |
| decyldimethylamine oxide | 3 | 2.4 | 4 | 2.4 | 2.4 | 2.4 | 3 | 3 | 3 | 3 |
| C₉₋₁₁ alcohol ethoxylate, 6 | 5.5 | 5.5 | 3 | — | — | 2 | 3 | 3 | 3 | 3 |
| moles EO | | | | | | | | | | |
| C₁₂₋₁₅ alcohol ethoxylate, 9 | — | — | — | 5 | 3 | — | — | — | — | — |
| moles EO | | | | | | | | | | |
| ethoxylated coco-fatty acid | — | — | 2 | — | 2 | — | 2 | 2 | 2 | 2 |
| PEG-6 cocoamide | 2 | — | — | — | — | — | — | — | — | — |
| PEG-8 laurate | — | — | — | — | — | — | — | — | — | — |
| PEG-12 dilaurate | — | — | — | — | — | — | — | — | — | — |
| EO/PO block copolymer1 | — | — | — | — | — | — | — | — | — | — |
| EO/PO block copolymer2 | — | — | — | — | — | — | — | — | — | — |
| quaternary ammonium | 1.5 | 1 | 1.5 | 1 | 1.5 | 1 | 1.5 | 1.5** | 1.5 | 1.5 |
| complex with saccharinate | | | | | | | | | | |
| counterion | | | | | | | | | | |
| coloring agent | 0.0056 | 0.0056 | 0.0056 | 0.056 | 0.056 | 0.0056 | 0.0056 | 0.0056 | 0.0056 | 0.0056 |
| fragrance (proprietary) | 0.3 | 0.3 | 0.3 | 0.3 | 0.3 | 0.3 | 0.3 | 0.3 | 0.3 | 0.3 |
| sodium metasilicate | — | — | — | — | — | — | — | — | 0.1 | — |
| deioinized water | q.s. | q.s. | q.s. | q.s. | q.s. | q.s. | q.s. | q.s. | q.s. | q.s. |

**the quaternary ammonium complex with saccharinate counterion was supplied as a solid material, which was first dissolved in n-methyl-pyrrolidone in a respective w/w ratio of 1:2, then added to the further constituents to produce the example formulation

All of the formulations on Table 1 indicated in weight percent. Deionized water was added in quantum sufficient, “q.s.” to provide the balance to 100% wt. of each of the example compositions.

The identity of the constituents indicated on Table 1 are indicated on the following Table 2.

TABLE 2

| Constituent | Supplied by: |
|---|---|
| decyldimethylamine oxide | AMMONYX DO (30% wt. actives) or |
| | AMMONYX DO (40% wt. actives) (ex. |
| | Stepan Co.) |
| lauryldimethyl amine oxide | AMMONYX LO (30% wt. actives) (ex. |
| | Stepan Co.) |
| C₉₋₁₁ alcohol ethoxylate, 6 moles EO | NEODOL 91-6 (98-100% wt. actives) (ex. |
| | Shell) |
| C₉₋₁₁ alcohol ethoxylate, 8 moles EO | NEODOL 91-8 (98-100% wt. actives) (ex. |
| | Shell) |
| C₈₋₁₀ alcohol ethoxylate, 4.5 moles EO | ALFONIC 810-4.5 (98-100% wt. actives) |
| C₁₂₋₁₅ alcohol ethoxylate, 9 moles EO | NEODOL 25-9 (98-100% wt. actives) (ex. Shell) |
| PEG-8 laurate | STEPAN PEG 400 ML (98-100% wt. |
| | actives) (ex. Stepan Co.) |
| PEG-12 dilaurate | STEPAN PEG 600 ML (98-100% wt. |
| | actives) (ex. Stepan Co.) |
| EO/PO block copolymer1 | PLURONIC L92 (100% wt. actives) (ex. |
| | BASF) |
| EO/PO block copolymer2 | PLURONIC L64 (100% wt. actives) (ex. |
| | BASF) |
| ethoxylated coco-fatty acid | STEPANEX 400 MC (98-100% wt. actives) |
| | (ex. Stepan Co.) |
| PEG-6 cocoamide | NINOL C-5 (100% wt. actives) (ex. Stepan |
| | Co.) |
| quaternary ammonium complex with | ONYXIDE 3300 (33% wt. actives, balance |
| saccharinate counterion | ethanol) (ex. Stepan Co.) |
| coloring agent | SANDOLAN BLUE 180 (ex. Clariant Inc.) |
| fragrance (proprietary) | proprietary fragrance composition |
| Sodium carbonate | Sodium carbonate (100% wt. actives), |
| | corrosion inhibitor |
| Sodium molybdate | Sodium molybdate (100% wt. actives), |
| | corrosion inhibitor |
| deioinized water | deionized water |

Compositions Ex. 1 and Ex. 2 of Table 1 were further provided to an aerosol container in a proportion of 93 parts by weight of an example composition with 7 parts by weight of a propellant, here “A-17” hydrocarbon propellant (described as being substantially n-butane,) was pressurized to 20-30 psi and sealed. These aerosolized compositions were easily dispensed from the containers via a conventional aerosol valve.

### Evaluation of Antimicrobial Efficacy:

A sample of the composition of Example 1 as described on Table 1 above was evaluated in order to evaluate their antimicrobial efficacy against Staphylococcus aureus (gram positive type pathogenic bacteria) (ATCC 6538), Salmonella choleraesuis (gram negative type pathogenic bacteria) (ATCC 10708) and Escherichia coli (ATCC 43888). The testing was performed in accordance with the protocols outlined in “Use-Dilution Method”, Protocols 955.14, 955.15 and 964.02 described in Chapter 6 of “Official Methods of Analysis”, 16^{th} Edition, of the Association of Official Analytical Chemists; “Germicidal and Detergent Sanitizing Action of Disinfectants”, 960.09 described in Chapter 6 of “Official Methods of Analysis”, 15^{th} Edition, of the Association of Official Analytical Chemists; or American Society for Testing and Materials (ASTM) E 1054-91 the contents of which are herein incorporated by reference. This test is also commonly referred to as the “AOAC Use-Dilution Test Method”.

The composition used in the test were the aerosol formulations which were produced as described above, namely by combining 93 parts by weight of the formulation according to Ex. 1 with 7 parts by weight of a the A-17 hydrocarbon propellant. For use in the test, quantities of the discharged prepared aerosol formulation were collected in a sterile container, and the foam formed was allowed to collapse and dissipate into a liquid prior to its use in the test.

Prior to testing, the collected composition of Ex. 1 was first diluted with sterile deionized water to two form standard dilutions, 1:82 and 1:96 (v/v, example composition:water). The test substrates were sterile stainless steel penicylinders as specified by the AOAC Use-Dilution Test Method. Testing was performed at ambient temperatures in the range of 19.3-20.7° C.

As is appreciated by the skilled practitioner in the art, the results of the AOAC Use-Dilution Test Method indicates the number of test substrates wherein the tested organism remains viable after contact for 10 minutes with at test disinfecting composition/total number of tested substrates (cylinders) evaluated in accordance with the AOAC Use-Dilution Test. Thus, a result of “0/60” indicates that of 60 test substrates bearing the test organism and contacted for 10 minutes in a test disinfecting composition, 0 or 1 test substrates had viable (live) test organisms at the conclusion of the test. Such a result is excellent, illustrating the excellent disinfecting efficacy of the tested composition. Similarly, a result of “0/10” indicates that 10 test substrates bearing the test organism and contacted for 10 minutes in a test disinfecting composition, 0 or 1 test substrates had viable (live) test organisms at the conclusion of the test. Such a result is excellent, illustrating the good disinfecting efficacy of the tested composition, although these test results are less statistically accurate than tests utilizing a larger number of test substrates.

Results of the antimicrobial testing are indicated on the Table, below. The reported results indicate the number of test cylinders with live test organisms/number of test cylinders tested for each example formulation and organism tested; in several instances plural tests for a test organism are reported when several tests against the same test organism was repeated.

TABLE
Antimicrobial Efficacy (Ex. 1 formulation)

| test organism | Test series | Dilution (v/v) | Test result |
|---|---|---|---|
| Salmonella choleraesuis | 1 | 1:96 | 1/60 |
| Salmonella choleraesuis | 2 | 1:96 | 1/60 |
| Salmonella choleraesuis | 3 | 1:96 | 1/60 |
| Staphylococcus aureus | 1 | 1:82 | 0/60 |
| Staphylococcus aureus | 2 | 1:82 | 0/60 |
| Staphylococcus aureus | 3 | 1:82 | 0/60 |
| Escherichia coli | 1 | 1:82 | 0/10 |
| Escherichia coli | 2 | 1:82 | 0/10 |
| Escherichia coli | 3 | 1:82 | 0/10 |

As may be seen from the results indicated above, the compositions according to the invention provide excellent sanitizing benefits to hard surfaces as demonstrated by the excellent antimicrobial efficacy of these compositions against known bacteria commonly found in bathroom, kitchen and other environments. Such results are excellent particularly in view of the high dilution of the composition in water used to perform the test; the tested dilutions of 1:96 and 1:82 are higher than the commonly tested dilution ratio of 1:64 which indicates the excellent antimicrobial efficacy of the composition according to the invention. Such an advantages clearly illustrate the superior characteristics of the compositions, the cleaning and antimicrobial benefits of the inventive compositions even in more dilute mixtures as demonstrated. Such is particularly striking when it is to be considered that when packaged in an aerosol form, or when used directly as a non-aerosolized concentrate composition, or at lesser aqueous dilutions than those used in the test reported above, the inventive compositions are expected to have even greater antimicrobial efficacy.

The remaining example compositions described on Table 1 are expected to provide similarly satisfactory antimicrobial efficacy.

As indicated by the reported results the compositions according to the invention provide excellent disinfecting benefits as evidenced by the excellent antimicrobial efficacy of these compositions against known bacteria commonly found in bathroom, kitchen and other environments. Such advantages clearly illustrate the superior characteristics of the compositions, the antimicrobial benefits attending its use which is not before known to the art.

### Evaluation of Storage Stability

Samples of the Ex. 1 and Ex. 2 compositions were subjected to freeze/thaw stability evaluation wherein the characteristics of the composition were observed at room temperature (68° F., 20° C.), after being frozen and permitted to return to room temperature, as well at a reduced temperature of 4° C. In each instance the compositions did not suffer phase separation or discoloration of the compositions under these testing and temperature conditions.

Aliquot samples of the Ex. 1 and Ex. 2 compositions were subjected to storage stability evaluations wherein aliquots of the Ex. 1 and Ex. 2 compositions were stored at room temperature and at the elevated temperature of 120° F. (49° C.) for 4, 8 and 12 weeks. It was observed that the following storage of the compositions for 4 weeks, 8 weeks, and 12 weeks both at room temperature and at the elevated temperature, the aliquots exhibited good stability without suffering phase separation.

While the invention is susceptible of various modifications and alternative forms, it is to be understood that specific embodiments thereof have been shown by way of example which are not intended to limit the invention to the particular forms disclosed; on the contrary the intention is to cover all modifications, equivalents and alternatives falling within the scope and spirit of the invention as expressed in the appended claims.

1. An disinfecting or sanitizing composition which comprises:
one or more poorly aqueous soluble quaternary ammonium compounds;
one or more nonionic surfactants, a propellant;
optionally one or more further surfactants;
optionally one or more further optional constituents;
and, water;
wherein the composition is largely aqueous in nature and includes not more than 20% wt. of one or more organic solvents.

2. An composition according to claim 1 wherein the composition comprises not more than 16% wt. of one or more organic solvents.

3. An composition according to claim 2 wherein the composition comprises not more than 14% wt. of one or more organic solvents.

4. An composition according to claim 3 wherein the composition comprises not more than 12% wt. of one or more organic solvents.

5. An composition according to claim 4 wherein the composition comprises not more than 10% wt. of one or more organic solvents.

6. An aerosol composition according to claim 1 which includes an aerosol propellant composition.

7. An aerosol composition according to claim 6 which includes an aerosol propellant composition based on volatile organic compounds.

8. An aerosol composition aerosol composition according to claim 6 which includes an aerosol propellant composition which contain no volatile organic compounds.

9. An aerosol container comprising a composition according to any of claims 1-5 and 7-8.

10. A non-aerosol composition according to claim 1.

11. A non-aerosol composition according to claim 1 comprising not more than 5% wt. of volatile organic compounds.

12. A non-aerosol composition according to claim 1 comprising not more than 4% wt. of volatile organic compounds.

13. A non-aerosol composition according to claim 1 comprising not more than 3% wt. of volatile organic compounds.

14. A method for the treatment of surfaces, particularly hard surfaces, wherein the presence of undesired microorganisms are suspected which method includes the step of applying a disinfecting or sanitizing effective amount of a composition according to any preceding claim to said surface.
